(19) United States
(12) Patent Application Publication
(10) Pub. No.: US 2011/0261644 A1
(43) Pub. Date: Oct. 27, 2011

(54) MIXER FLOW DIRECTION APPARATUS AND METHOD

(75) Inventors: Bernd Gigas, Rochester, NY (US); Werner van Vuuren, Gauteng (ZA)

(73) Assignee: SPX Corporation, Charlotte, NC (US)

(21) Appl. No.: 12/767,235

(22) Filed: Apr. 26, 2010

(51) Int. Cl. B01F 7/00

(52) U.S. Cl. 366/293; 366/279

(57) ABSTRACT

A mixing assembly for mixing settled solids in a liquid or the like, having a longitudinal axis, comprising: a mixing vessel having an apex. The assembly includes a directional tube having a first end and a second end wherein said second end, wherein the directional tube further comprises at least one slot located proximate to said second end wherein said at least one slot extends generally normal to the longitudinal axis. The assembly further includes an impeller disposed within the directional tube, connected to a rotatable shaft.

### FIELD OF THE INVENTION

This invention relates generally to a method and apparatus for mixing systems that for the improvement of flow deep into conical or cone geometry tanks, for example. More particularly, the present invention relates, for example, to an improved directional or draft tube system or the like, for use with mixing conditions utilizing vessels having cone geometries, for example.

### BACKGROUND OF THE INVENTION

Mixing tank arrangements for processing liquid and solid material sometimes employ a draft tube or directional tube apparatuses, or the like to assist with flow of solid suspension mixing. The mixing tank arrangements typically employ a down-pumping impeller near the top of the draft tube along with flow control vanes near the down-pumping impeller. Typical draft tube designs utilized in the art also may include vertical slots extending from the bottom or bottom rim of the draft tube to above the level to which solids may settle. The vertical slots function to allow the startup of the mixing tank in conditions where the solids have settled by solids by enabling the solids that have settled in the mixing tank, due to inactivity of the mixing tank, to pass through the tops of the vertical slots. The flow of the settled solids through the tops of the vertical slots usually functions to scour away and re-suspend the settled solid material in the tank region adjacent the vertical slots.

Many processes require suspension of solid particles in a liquid within a tank. Mixing tank arrangements utilizing a draft tube are commonly used to accomplish the aforementioned suspension as previously discussed above. Oftentimes circumstances arise which require that these mixing processes be shut down or halted for various reasons and long periods of time. During these shut-down times or periods of inactivity, the solids that are suspended in the liquid mixture begin to settle at the bottom of the mixing tank. As previously discussed, draft tubes often extend into the mixing vessel in which they are disposed so that their lower ends are submerged in, or extend into, the settled solids. This orientation or positioning of the draft tube wherein the lower end of the draft tube is submerged, oftentimes causes difficulty during startup of the mixing vessel. This difficulty oftentimes is the result of the settled solids clogging the lower end of the draft tube, preventing the impeller from being started.

Methods currently employed in the art that address the aforementioned startup problem include first, draining the mixing vessel and removing or shoveling the settled solid material away from the bottom of the draft tube to clear the opening in the bottom of the draft tube. Once the opening of the draft tube is cleared, the mixing vessel is refilled with the liquid and the impeller is started and the solids are then added back to the mixing vessel.

Another method currently employed in the art is to set up and arrange pipes that extend to the bottom of the mixing vessel. These pipes proceed to extend into the vessel and into the bottom region of the draft tube. Next, pressurized or compressed air is provided or forced through the pipes to agitate and loosen the settled solids. The compressed air enables the liquid to move through solid material and begin to scour away and suspend and/or re-suspend the particles of the settled solids.

Still another method currently used in mixing assemblies or mixing apparatuses is to limit the length of the draft tube and not extend the draft tube a specified distance. For example, in these arrangements, the draft tube extends into the mixing vessel however it does not extend into or below the level of the settled solids.

The aforementioned solids re-suspension methods and apparatuses have drawbacks however. Some methods and apparatuses, as previously discussed, require expensive auxiliary equipment adding cost while others require shut-down time which also adds cost to the operation of the mixing vessel. Furthermore, when solids loading of the mixing vessel is increased, oftentimes the impeller is unable to provide the necessary head to overcome the mixing system resistance. In these increased solids loading conditions, re-suspension may cause the mixing system power requirements to increase until possible overload of the motor driving the impeller. Furthermore, in draft tube systems similar to the ones previously described, motor overloads and subsequent process failure may be experienced in start up conditions having high concentration of settled solids. This is oftentimes due to mixing systems lacking significant enough velocity head to break the interface between the liquor and the settled solids without overloading or short circuiting the mixing system flow pattern.

Another drawback to the above-discussed draft tube arrangements is that they are often utilized in flat-bottom mixing vessels and are not conducive to being employed with cone shaped or conical shaped vessels. Cone shaped or conical shaped vessels are oftentimes preferred in mixing applications such as pharmaceutical applications and/or mining slurry applications where it is advantageous to easily drain the contents of the mixing vessel.

Accordingly, there is a need in the art to provide an directional tube apparatus and method for the mixing of solids and slurries or the like, in vessels have non-flat bottom vessels. More specifically, it is desirable to provide a directional tube apparatus for use with cone shaped and conical shaped mixing vessels.

### SUMMARY OF THE INVENTION

The foregoing needs are met, to a great extent, by the present invention, wherein aspects of a mixing assembly start-up method are provided.

In accordance with an embodiment of the present invention, a mixing assembly for mixing settled solids in a liquid or the like, having a longitudinal axis is provided, comprising: a mixing vessel comprising: a first upper wall that extends generally parallel to the longitudinal axis; a second upper wall that extends generally parallel to the longitudinal axis and opposes sais first upper wall a first lower wall that extends from said first upper wall that extends toward the longitudinal axis away from said first upper wall; a second lower wall that extends from said second upper wall that extends toward the longitudinal axis away from said second upper wall, wherein said first and second lower walls meet at an apex; a directional tube having a first end and a second end wherein said second end, wherein said directional tube further comprises at least one slot located proximate to said second end wherein said at least one slot extends generally normal to the longitudinal axis; and a first impeller disposed within said directional tube, connected to a rotatable shaft.

In accordance with another embodiment of the present invention, a method for suspending or mixing solids in a liquid using a mixing assembly having a longitudinal axis is provided, comprising: a mixing vessel comprising: a first upper wall that extends generally parallel to the longitudinal axis; a second upper wall that extends generally parallel to the longitudinal axis and opposes said first upper wall a first lower wall that extends from said first upper wall that extends toward the longitudinal axis away from said first upper wall; a second lower wall that extends from said second upper wall that extends toward the longitudinal axis away from said second upper wall, wherein said first and second lower walls meet at an apex; a directional tube having a first end and a second end wherein said second end, wherein said directional tube further comprises at least one slot located proximate to said second end wherein said at least one slot extends generally normal to the longitudinal axis; and a first impeller disposed within said directional tube, connected to a rotatable shaft, said steps comprising: rotating the first impeller in a first rotational direction for a first period of time, wherein said rotating of the impeller in the first rotational direction causes the liquid to flow in a first axial direction along the longitudinal axis through the directional tube away from the first end and out through the at least one slot; and forcing the fluid through to contact the apex as it exits the at least one slot.

In accordance with yet another embodiment of the present invention, a mixing assembly for mixing settled solids in a liquid or the like, having a longitudinal axis is provided, comprising: a mixing means comprising: a first upper wall that extends generally parallel to the longitudinal axis; a second upper wall that extends generally parallel to the longitudinal axis and opposes sais first upper wall a first lower wall that extends from said first upper wall that extends toward the longitudinal axis away from said first upper wall; a second lower wall that extends from said second upper wall that extends toward the longitudinal axis away from said second upper wall, wherein said first and second lower walls meet at an apex; a directional means having a first end and a second end wherein said second end, wherein said directional means further comprises at least one slot located proximate to said second end wherein said at least one slot extends generally normal to the longitudinal axis; and a first agitator disposed within said directional means, connected to a rotatable shaft, said steps comprising: means for rotating the first agitator means in a first rotational direction for a first period of time, wherein said means for rotating of the agitator in the first rotational direction causes the liquid to flow in a first axial direction along the longitudinal axis through the directional tube away from the first end and out through the at least one slot; and means for forcing the fluid through to contact the apex as it exits the at least one slot.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic cross-sectional view of a mixing assembly having a directional tube in accordance with an embodiment of the present invention.

FIG. 2 is a schematic view of the mixing assembly depicted in FIG. 1 during operation in accordance with a preferred embodiment of the present invention.

### DETAILED DESCRIPTION

Various preferred embodiments of the present invention provide for a re-suspending of settled solids, such as alumina, in mixing systems or the like. It should be understood, however, that the present invention is not limited in its application to mixings systems or the suspension of alumina, but, for example, may be used with other processes and/or apparatuses requiring the suspension or re-suspension of solids. Preferred embodiments of the invention will now be further described wither reference to the drawing figures, in which like reference numerals refer to like parts throughout.

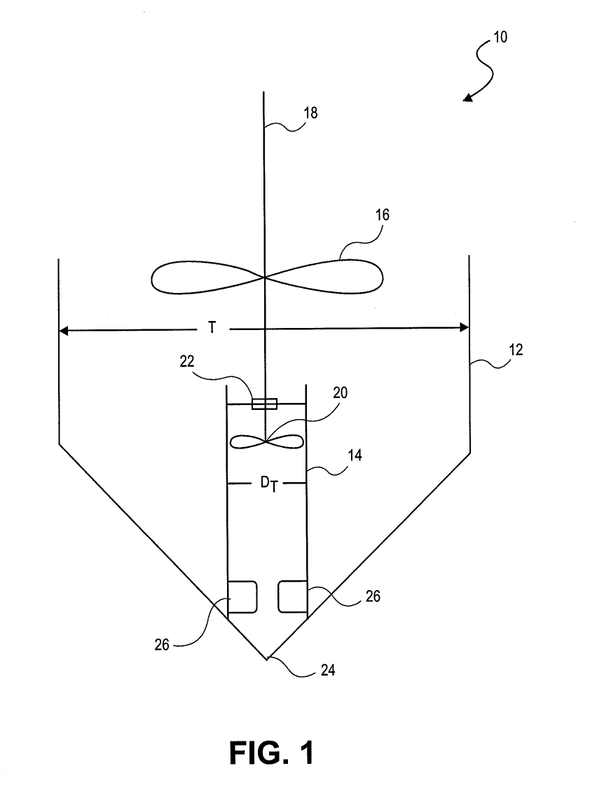

Referring now to FIG. 1, a mixing assembly, generally designated 10, is depicted for mixing a liquid in which a solid material is suspended. The mixing assembly 10 includes a mixing vessel 12 and a directional tube or draft tube 14 positioned at a central location within the mixing vessel 12. The mixing assembly 10 also includes an upper impeller 16 that is sized for the process for which the assembly is being utilized. This upper impeller 16 may be a radial impeller, up-pumping impeller, down pumping impeller or any combination thereto. As illustrated in FIG. 1, the impeller 16 is connected to a rotatable shaft 18 which is in turn connected to a gear drive which is driven by a motor (each not pictured). The motor and gear drive operate to rotate or turn to drive the shaft.

As illustrated in FIG. 1, the assembly 10 further comprises a second impeller 20 attached to the shaft 18. As depicted, the impeller 20 is disposed within the directional or draft tube 14. In one embodiment of the present invention, the impeller 20 is preferably an axial down pumping impeller however depending upon the process in which the assembly 10 is used, alternative impellers may be employed. As previously, discussed, the impeller 20 is mounted to the shaft 18, however a steady bearing 22 may be provided to assist with support and stabilization of said shaft 18 and impeller 20.

The aforementioned motor and drive mechanism operate such that they can drive the shaft 18 in a first direction so that the second impeller 20 pumps, or down pumps, liquid material downward through the directional or draft tube 14. The motor and drive mechanism may also operate in an alternative mode to rotate or turn the shaft 18 in an opposite, second direction so that the second impeller 20 pumps, or up pumps, the liquid material upward through the directional or draft tube 14.

Turning now more specifically to directional or draft tube 14, the directional or draft tube 14 is conduit attached or mounted to the vessel 12. Preferably, the directional or draft tube 14 is mounted to the vessel 14 such that it extends vertically above the apex 24 of vessel 14. As illustrated in FIG. 1, the vessel 14 has a diameter “T” whereas the conduit has a diameter D_{T}. In one preferred embodiment of the present invention, D_{T}/T is greater than or equal to 0.03 and equal to 0.7. In another embodiment of the present invention, D_{T}/T is approximately 0.2 to approximately 0.3.

As depicted in FIG. 1, the directional or draft tube 14 has a series of radial cut-outs or slots 26 perforating the lower portion of the wall of the directional or draft tube 14. Preferably, said slots 26 positioned in the vicinity or adjacent the apex of the vessel 12. Depending upon the application, the directional or draft tube 14 may employ more or less slots 26. Moreover, depending upon the application, the slots may vary in size and geometry.

For example, the slots can have a tapered geometry. This exemplary geometry of the slots 26 can provide less resistance to liquid flow. The above-described slots 26 typically allow for a the apex 24 area of the vessel 12 to be sufficiently mixed during operation. This orientation also allows for the desired scouring away and clearing of the settled solids at the bottom of the mixing vessel 12.

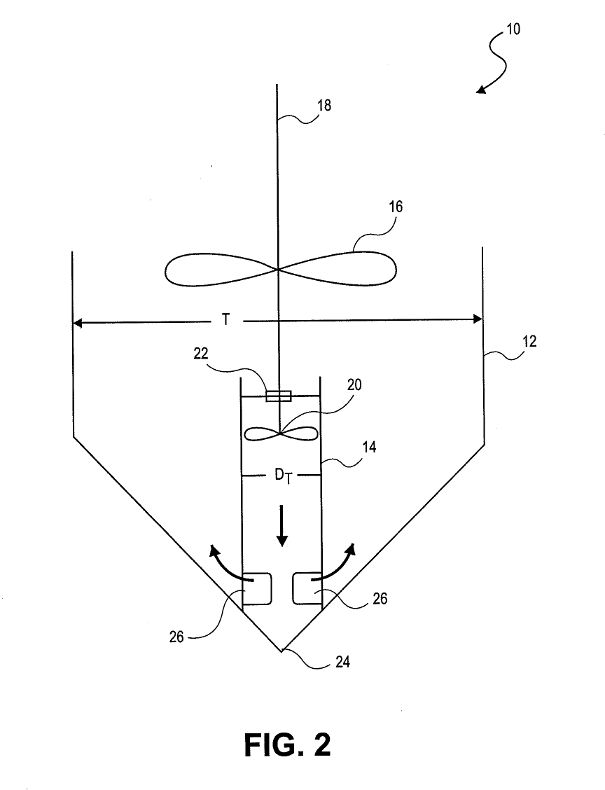

Turning now to FIG. 2, during standard operation of the mixing assembly 10, the mixing vessel 12 is charged with liquid such as liquor and solid material such as alumina and the impeller 20 is driven in the aforementioned first direction. During standard operation, the rotation of the impeller 20 down pumps, forcing a jet stream of liquid downward through the inside of the directional or draft tube 14 toward the bottom of the mixing vessel 12 as indicated by the arrow. As the liquid is forced downward through the directional or draft tube 14, the flow or jet stream approaches the bottom of the mixing vessel 12 where it is turned and deflected upward and outward, as indicated by arrows, creating a flow rising around the apex 24 of the mixing vessel 12.

The above-described flow pattern that exists during the standard operation of the mixing assembly 10 functions to scour away and maintain the liquid suspension of the solid materials that tend to settle in conical or cone shaped mixing vessels. As the liquid flow approaches the top of the directional or draft tube 14, the liquid with solid material suspended therein, may flow inward toward the directional or draft tube 14 away from the outer walls of the vessel 12. It again is pumped downward through the directional or draft tube 14, as previously described, in continuous circulation within the mixing vessel 12.

The assembly 10 may be alternatively operated in an alternative mode as previously discussed. By alternative mode, it understood that the impeller 20 is driven or operated in the reverse or the opposite direction than during standard operation of the mixing assembly 10. The impeller 20 is rotated in the reverse direction, causing upflow from the suction head within the directional or draft tube 14. This action creates a head differential. The resulting flow will discharge as a swirling area of liquor (flow) in the tank and the draft tube liquor initially begins to re-suspend the settled solids. The aforementioned re-suspension of the settled solids provides a higher density liquor which is capable of breaking through the liquid-solid interface of the mixing system 10 that results from the settling of the solids. The aforementioned re-suspension of the settled solids also functions to re-suspend a portion of the settled solids so as to uncover the slots 26 of the directional or draft tube 14.

The above-described operation of the mixing assembly 10 in the alternative mode, i.e., with the impeller 20 driven or operated in the reverse or the opposite direction than rotation during standard operation, enables the mixing assembly 10 to be started in conditions having high concentration of settled solids. The above-described operation of the mixing assembly 10 in the alternative mode also prevents the likelihood of motor overload during start-up of the mixing assembly 10 due to high head conditions which can be caused by high system head resulting from the high concentration of settled solids.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A mixing assembly for mixing settled solids in a liquid or the like, having a longitudinal axis, comprising:
a mixing vessel comprising:
a first upper wall that extends generally parallel to the longitudinal axis;
a second upper wall that extends generally parallel to the longitudinal axis and opposes sais first upper wall
a first lower wall that extends from said first upper wall that extends toward the longitudinal axis away from said first upper wall;
a second lower wall that extends from said second upper wall that extends toward the longitudinal axis away from said second upper wall, wherein said first and second lower walls meet at an apex;
a directional tube having a first end and a second end wherein said second end, wherein said directional tube further comprises at least one slot located proximate to said second end wherein said at least one slot extends generally normal to the longitudinal axis; and
a first impeller disposed within said directional tube, connected to a rotatable shaft.

2. The mixing assembly according to claim 1, further comprising a second impeller connected to said rotatable shaft at a position exterior to the directional tube.

3. The mixing assembly accordingly to claim 2, wherein said second impeller is a radial impeller.

4. The mixing assembly accordingly to claim 2, wherein said second impeller is an axial impeller.

6. The mixing assembly accordingly to claim 2, wherein said second impeller is a down pumping impeller.

7. The mixing assembly accordingly to claim 2, wherein said second impeller is an up-pumping impeller.

8. The mixing assembly according to claim 1, wherein said first impeller is an axial impeller.

9. The mixing assembly according to claim 1, wherein said first impeller is a down pumping impeller.

10. The mixing assembly according to claim 1, wherein said first impeller is an up-pumping impeller.

11. The mixing assembly according to claim 1, wherein said mixing vessel has a conical geometry.

12. The mixing assembly accordingly to claim 1, wherein said mixing vessel has a diameter T and said directional tube has a diameter D_{T} and wherein D_{T}/T is approximately 0.03 to approximately 0.7.

13. The mixing assembly according to claim 6, wherein D_{T}/T is approximately 0.2 to approximately 0.3.

14. The mixing assembly according to claim 2, further comprising a steady bearing positioned about the rotatable axis between said firs impeller and said second impeller.

15. A method for suspending or mixing solids in a liquid using a mixing assembly having a longitudinal axis, comprising:
a mixing vessel comprising: a first upper wall that extends generally parallel to the longitudinal axis; a second upper wall that extends generally parallel to the longitudinal axis and opposes sais first upper wall a first lower wall that extends from said first upper wall that extends toward the longitudinal axis away from said first upper wall; a second lower wall that extends from said second upper wall that extends toward the longitudinal axis away from said second upper wall, wherein said first and second lower walls meet at an apex; a directional tube having a first end and a second end wherein said second end, wherein said directional tube further comprises at least one slot located proximate to said second end wherein said at least one slot extends generally normal to the longitudinal axis; and a first impeller disposed within said directional tube, connected to a rotatable shaft, said steps comprising:
rotating the first impeller in a first rotational direction for a first period of time, wherein said rotating of the impeller in the first rotational direction causes the liquid to flow in a first axial direction along the longitudinal axis through the directional tube away from the first end and out through the at least one slot; and
forcing the fluid through to contact the apex as it exits the at least one slot.

16. The method according to claim 15, further comprising rotating the first impeller in a second rotational direction opposite the first rotational direction for a second period of time, wherein said rotating of the first impeller in the second rotational direction causes the liquid to flow in a second axial direction along the longitudinal axis opposite the first axial direction.

17. The method according to claim 16, wherein the step of rotating the impeller in the first rotational direction for the first period of time causes an up-pumping flow orientation within the draft tube.

18. The method according to claim 16, wherein the step of rotating the impeller in the second rotational direction for the second period of time causes a down pumping flow orientation within the draft tube.

19. A mixing assembly for mixing settled solids in a liquid or the like, having a longitudinal axis, comprising:
a mixing means comprising: a first upper wall that extends generally parallel to the longitudinal axis; a second upper wall that extends generally parallel to the longitudinal axis and opposes sais first upper wall a first lower wall that extends from said first upper wall that extends toward the longitudinal axis away from said first upper wall; a second lower wall that extends from said second upper wall that extends toward the longitudinal axis away from said second upper wall, wherein said first and second lower walls meet at an apex; a directional means having a first end and a second end wherein said second end, wherein said directional means further comprises at least one slot located proximate to said second end wherein said at least one slot extends generally normal to the longitudinal axis; and a first agitator disposed within said directional means, connected to a rotatable shaft, said steps comprising:
means for rotating the first agitator means in a first rotational direction for a first period of time, wherein said means for rotating of the agitator in the first rotational direction causes the liquid to flow in a first axial direction along the longitudinal axis through the directional tube away from the first end and out through the at least one slot; and
means for forcing the fluid through to contact the apex as it exits the at least one slot.

20. The mixing assembly accordingly to claim 19, further comprising a means rotating the impeller in the second rotational direction for the second period of time causes a down pumping flow orientation within the draft tube.
